(19) United States
(12) Patent Application Publication
(10) Pub. No.: US 2008/0154464 A1
(43) Pub. Date: Jun. 26, 2008

(54) Automatic Parking control apparatus for vehicle

(75) Inventors: Takeshi Sasajima, Wako-shi (JP); Yoshimitsu Aiga, Wako-shi (JP); Takashi Asaba, Wako-shi (JP)

Correspondence Address: ARENT FOX LLP, 1050 CONNECTICUT AVENUE, N.W., SUITE 400, WASHINGTON, DC, 20036, US

(73) Assignee: Honda Motor Co., Ltd.

(21) Appl. No.: 11/979,167

(22) Filed: Oct. 31, 2007

(30) Foreign Application Priority Data
Dec. 26, 2006 (JP) JP2006-349096

(51) Int. Cl. B62D 6/00; G06F 19/00

(52) U.S. Cl. 701/42

(57) ABSTRACT

An automatic parking control apparatus for a vehicle, that performs a steering control, a movement control for moving the vehicle forward or backward at a low speed, and a stop control for stopping the vehicle. A parking space and an initial position of the vehicle is recognized. The parking control is performed so that the vehicle moves forward from the initial position; the steering wheel rotates in a first direction in order to move the vehicle forward from a first direction steering position in an opposite direction with respect to the parking space; the vehicle stops when the vehicle reaches a backward movement starting position; the steering wheel rotates in a second direction which is opposite to the first direction; and the vehicle moves backward into the parking space.

### BACKGROUND OF THE INVENTION

1. Field of the Invention

The present invention relates to an automatic parking control apparatus for a vehicle, wherein the automatic parking control apparatus automatically performs automatic parking control when parking the vehicle in a parking space located on a right or left side of the road relative to a moving direction of the vehicle.

2. Description of the Related Art

Japanese Patent Laid-open No. H10-114272 (JP '272) discloses an automatic steering system which controls a steering wheel of a vehicle to park the vehicle in a garage. According to the system disclosed in JP '272, a model steering angle corresponding to a moving distance of the vehicle is set based on a movement locus to a target stop position that is previously stored in a memory device. To park the vehicle in the garage, the steering wheel is controlled such that the actual steering angle coincides with the model steering angle.

The system disclosed in JP '272 performs the operation of automatically parking the vehicle in the garage only for the case where the road (passage) in front of the garage is wide enough that such a cutting operation of the steering wheel is not required. Therefore, a system is needed which can automatically park the vehicle in a parking space by performing a cutting operation of the steering wheel when the road is not wide enough to avoid the cutting operation.

### SUMMARY OF THE INVENTION

The present invention is made contemplating the above-described point, and an aspect of the invention is to provide an automatic parking control apparatus which can automatically park a vehicle in a parking space even when the road in front of the parking space is relatively narrow.

The present invention provides an automatic parking control apparatus for a vehicle which includes a steering device, a steering/movement controller, a recognizing device, an obstacle detector, and a position detector. The steering device steers a steering wheel of the vehicle. The steering/movement controller performs a steering control with the steering device, a movement control for moving the vehicle forward or backward at a low speed, and a stop control for stopping the vehicle. The recognizing device recognizes a parking space located on a side of the vehicle relative to a moving direction of the vehicle and an initial position of the vehicle with reference to a position of the parking space in response to a predetermined operation. The obstacle detector detects an obstacle located on an opposite side of the parking space relative to the moving direction of the vehicle. The position detector detects a position of the vehicle. The steering/movement controller performs the steering control, the movement control, and the stop control so that the vehicle moves forward from the initial position. The steering wheel rotates in a first direction in order to move the vehicle forward from a first direction steering position (rightward steering position PR) in an opposite direction with respect to the parking space. The vehicle stops when the vehicle reaches a backward movement starting position (PBS). The steering wheel rotates in a second direction, which is opposite to the first direction, and the vehicle moves backward into the parking space. Further, the steering/movement controller includes backward movement starting position calculator and steering position calculator. The backward movement starting position calculator calculates the backward movement starting position (PBS) as a position from where the vehicle is able to run so that a first predetermined portion (xfr, yfr) of the vehicle is kept away from the obstacle by a predetermined distance (DTH) or more when the vehicle moves backward to the parking space, wherein the first predetermined portion (xfr, yfr) is defined as a portion which passes a closest point to the obstacle. The steering position calculator calculates the first direction steering position (PR) as a position where a positional relationship between a second predetermined portion (xwl, ywl) of the vehicle and the parking space satisfies a predetermined positional relationship when the vehicle moves backward to the parking space from the backward movement starting position.

With the above-described structural configuration, the parking control is performed as follows. The vehicle moves forward from the initial position, and the steering wheel rotates in the first direction at the first direction steering position. The vehicle then moves forward in the opposite direction with respect to the parking space and stops when reaching the backward movement starting position. The steering wheel rotates in the second direction, which is opposite to the first direction, and the vehicle then moves backward into the parking space. The backward movement starting position is calculated as a position from where the vehicle is able to run so that the first predetermined portion of the vehicle is kept away from the obstacle by the predetermined distance or more when the vehicle moves backward to the parking space, wherein the first predetermined portion is defined as the portion which passes the closest point to the obstacle. The first direction steering position is calculated as a position where the positional relationship between the second predetermined portion of the vehicle and the parking space satisfies the predetermined positional relationship when the vehicle moves backward to the parking space from the backward movement starting position. Therefore, the vehicle moves backward without scraping the first predetermined portion of the vehicle against the obstacle and reaches the position where the positional relationship between the second predetermined portion of the vehicle and the parking space satisfies the predetermined proportional relationship. That is, the vehicle is able to accurately and easily move into the parking space or reach the position for enabling the cutting (hereinafter interchangeably referred to as “cutting”, “turning”, or “rotating”) operation of the steering wheel without scraping against any obstacle on the opposite side with respect to the parking space when the vehicle moves backward.

Preferably, the steering/movement controller performs the steering control so that a distance in a lateral direction between the vehicle and the parking space decreases when the vehicle moves forward from the initial position to the first direction steering position (PR).

With the above-described structural configuration, the steering control is performed so that the distance in the lateral direction between the vehicle and the parking space decreases when the vehicle moves forward from the initial position to the first direction steering position. That is, the vehicle moves closer in the lateral direction to the parking space before the steering wheel rotates in the first direction. Accordingly, when the distance in the lateral direction between the initial position of the vehicle and the parking space is great, the road (passage) width in front of the parking space is effectively used, thereby reducing a number of times the cutting operation needs to be performed until completing the parking operation.

Preferably, the automatic parking control apparatus further includes a second obstacle detector on a rear part of the vehicle, wherein the steering/movement controller performs a cutting wheel operation so that the vehicle stops when the second obstacle detector detects an obstacle during backward movement of the vehicle; the steering wheel rotates in the first direction; and the vehicle moves forward.

With the above-described structural configuration, the vehicle stops when the obstacle located behind the vehicle is detected during the backward movement of the vehicle, and the cutting or turning operation, wherein the steering wheel rotates in the first direction and the vehicle moves forward, is performed. Accordingly, the vehicle is accurately and easily able to park in the parking space even when the width of the road (passage) in front of the parking space is relatively narrow.

### BRIEF DESCRIPTION OF THE DRAWINGS

FIG. 1 is a schematic diagram of a vehicle and a control apparatus therefore according to one embodiment of the present invention;

FIGS. 2A and 2B illustrate an outline of the automatic parking control;

FIGS. 3 and 4 are flowcharts of a general configuration of the automatic parking control process;

FIGS. 5A and 5B illustrate a pulling over control;

FIGS. 6A and 6B illustrate a turning control;

FIG. 7 is a flowchart of the pulling-over control process executed in the automatic parking process of FIGS. 3 and 4;

FIG. 8 is a flowchart of the turning control process executed in the automatic parking process of FIGS. 3 and 4;

FIGS. 9 and 10 are flowcharts of a rightward steering position detecting process executed in the automatic parking process of FIG. 3;

FIG. 11 is a flowchart of a backward movement starting position detecting process executed in the automatic parking process of FIG. 3;

FIG. 12 illustrates the parameters indicative of coordinates and dimensions of the vehicle to be controlled;

FIG. 13 illustrates a sequential calculating method of a vehicle position and an inclination angle;

FIGS. 14A, 14B, 15A, and 15B illustrate a calculation of a predicted locus performed in the rightward steering position detecting process; and

FIGS. 16A-16C illustrate additional functions for performing the automatic parking.

### DETAILED DESCRIPTION OF THE PREFERRED EMBODIMENTS

Preferred embodiments of the present invention will now be described with reference to the drawings.

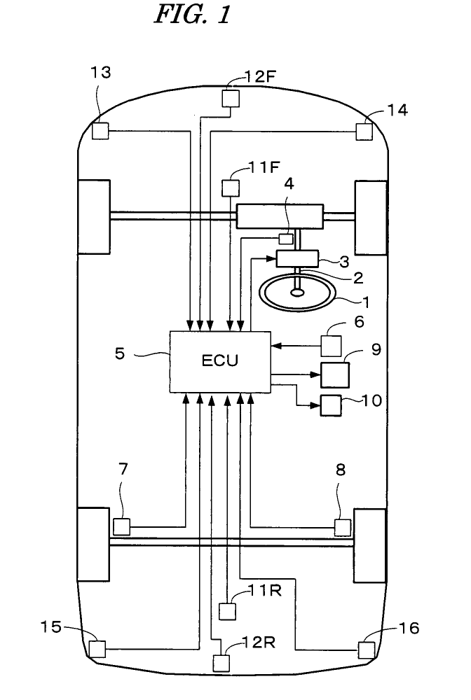

FIG. 1 is a schematic diagram of a vehicle and a steering control apparatus therefore according to one embodiment of the present invention. The vehicle is an automobile provided with a steering wheel 1 (steering wheel), a steering shaft 2, a steering actuator 3, a steering angle sensor 4, an electronic control unit 5 (hereinafter referred to as “ECU”), and an internal combustion engine, an automatic transmission, an accelerator pedal, a brake pedal, and the like (all of which are not shown). The steering actuator 3 has an electric motor which rotationally drives the steering shaft 2. The steering angle sensor 4 detects a rotational angle (steering angle) of the steering shaft 2. The ECU 5 performs the steering control. Further, a brake actuator 9, for actuating a brake, and a shift actuator 10, for shifting a shift lever position of the automatic transmission, are connected to the ECU 5. The vehicle is provided with a shift position sensor 6 for detecting a shift lever position SP of the automatic transmission. Further, a left wheel speed sensor 7 for detecting a left wheel speed VWL and a right wheel speed sensor 8 for detecting a right wheel speed VWR are located in the vicinity of a right-rear wheel or a left-rear wheel. The detection signals of the above-described sensors 4 and 6 to 8 are supplied to the ECU 5. A running speed VP of the vehicle is calculated as an average value of the left wheel speed VWL and the right wheel speed VWR.

Further, the vehicle is provided with a video camera 11F for obtaining a front view of the vehicle, a video camera 11R for obtaining a view behind the vehicle, a radar 12F facing forward from the vehicle, a radar 12R facing backward from the vehicle, and sonars 13, 14, 15, and 16. Each of the sonars 13 and 14 is mounted in the vicinity of a predetermined portion of a front bumper. The predetermined portion of the front bumper traces the outmost movement locus when the vehicle turns in forward movement. Each of the sonars 15 and 16 is mounted in the vicinity of a predetermined portion of a rear bumper. The predetermined portion of the rear bumper traces the outmost movement locus when the vehicle turns in backward movement.

The ECU 5 includes an input circuit, an output circuit, a CPU, a memory circuit, and the like. The ECU 5 recognizes a situation around the vehicle based on the signals supplied from the above-described sensors, the video cameras 11F and 11R, the radars 12F and 12R, and the sonar sensors 13 to 16. While performing the steering control with the steering wheel 1 through the steering actuator 3, the ECU 5 performs a switching control (movement control) for switching between forward and backward movement of the vehicle through the shift actuator 10 and a stop control of the vehicle through the brake actuator 9.

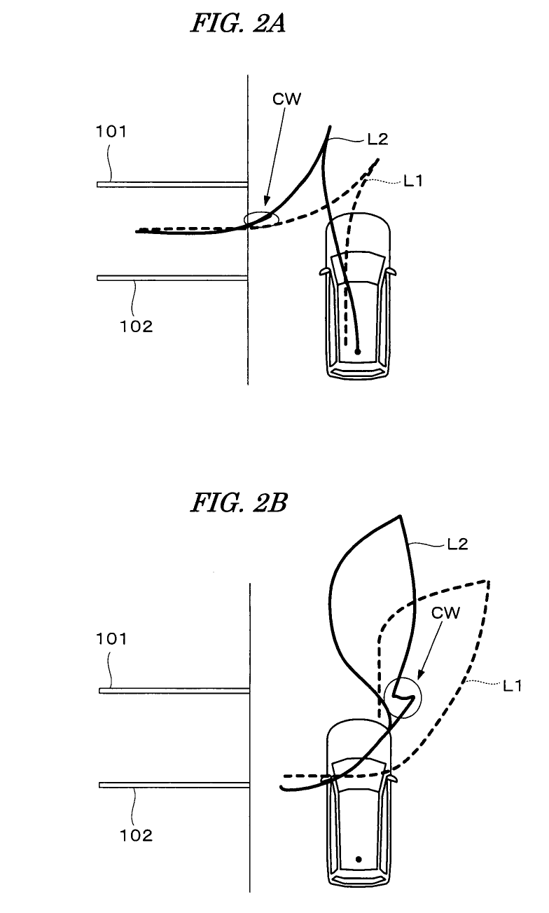

FIGS. 2A and 2B illustrate an outline of the automatic parking control of the vehicle according to this embodiment. FIG. 2A shows movement loci of the vehicle when parking the vehicle in the parking space which is defined by borderlines 101 and 102 (the vehicle position is represented by a central position of the two rear wheels of the vehicle). Conventional automatic parking control apparatuses perform the parking control on the assumption that the road or passage (hereinafter referred to as “passage”) in front of the parking space has sufficient width, wherein the vehicle moves along the locus shown by the dashed line L1 into the parking space. That is, the parking control is performed so that the vehicle moves forward during rotation of the steering wheel in the rightward direction, the vehicle stops, the vehicle moves backward during rotation of the steering wheel in the leftward direction, and the vehicle moves into the parking space.

On the other hand, in this embodiment, as shown by the solid line L2, the parking control is performed so that the vehicle moves forward and closer to the parking space, the steering wheel then rotates in the rightward direction, the vehicle stops, the vehicle then moves backward with rotation of the steering wheel in the leftward direction, and then the cutting or turning operation of the steering wheel is performed, if necessary, to maneuver the vehicle into the parking space (an example in which the cutting or turning operation of the steering wheel is performed once at the position indicated by the ellipses CW is shown in FIG. 2A). According to such parking control, the vehicle is maneuvered into the parking space even when the width of the passage in front of the parking space is relatively narrow.

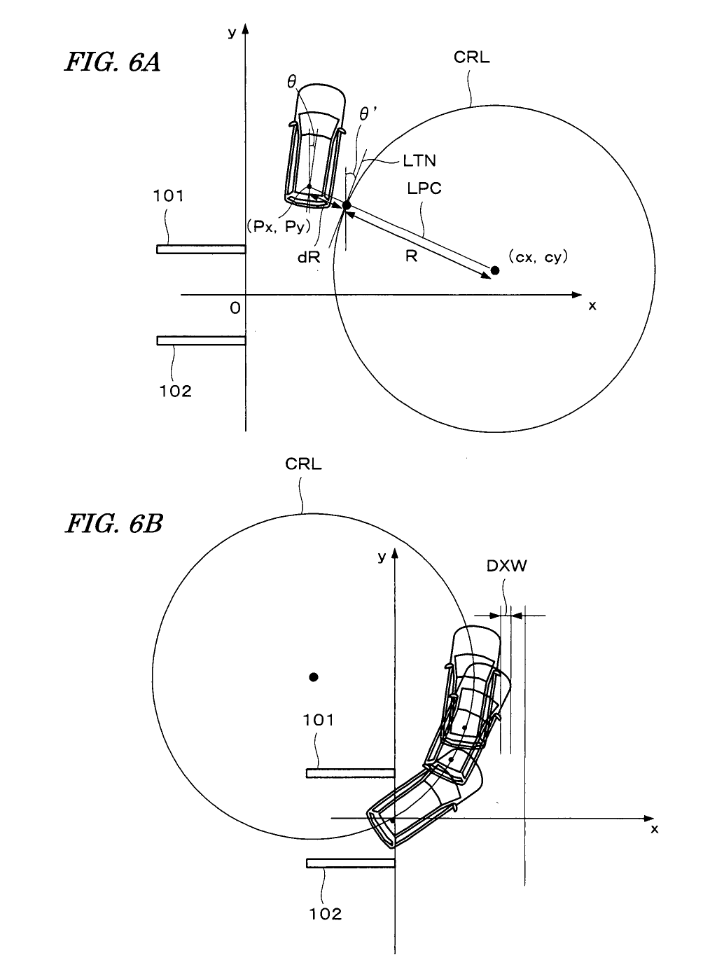

FIG. 2B shows loci (corresponding to the loci of FIG. 2A) of the predetermined portion of the front bumper. The predetermined portion protrudes most rightward during backward movement of the vehicle. It is confirmed in FIG. 2B that the vehicle can be maneuvered into the parking space even when the passage width in front of the parking space is relatively narrow. Further, as shown in FIG. 6B, the predetermined portion (right-front end) of the front bumper protrudes rightward by a distance DXW from the lateral position upon stoppage of the vehicle when the vehicle moves backward. Accordingly, the control contemplating this point is performed in the automatic parking control process described below.

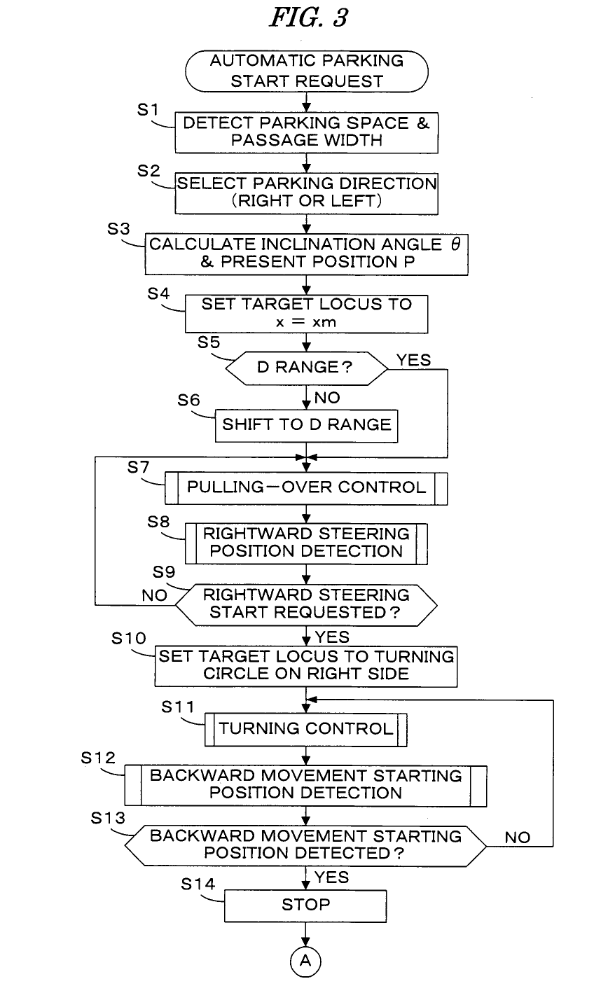

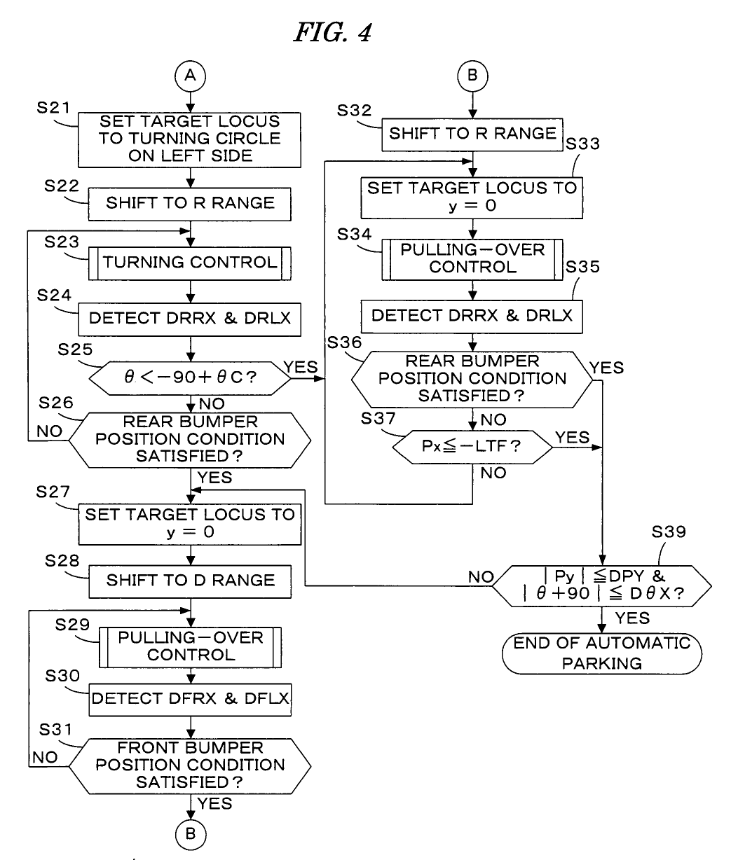

FIGS. 3 and 4 show a flowchart of a main routine of the automatic parking control process executed by the CPU in the ECU 5.

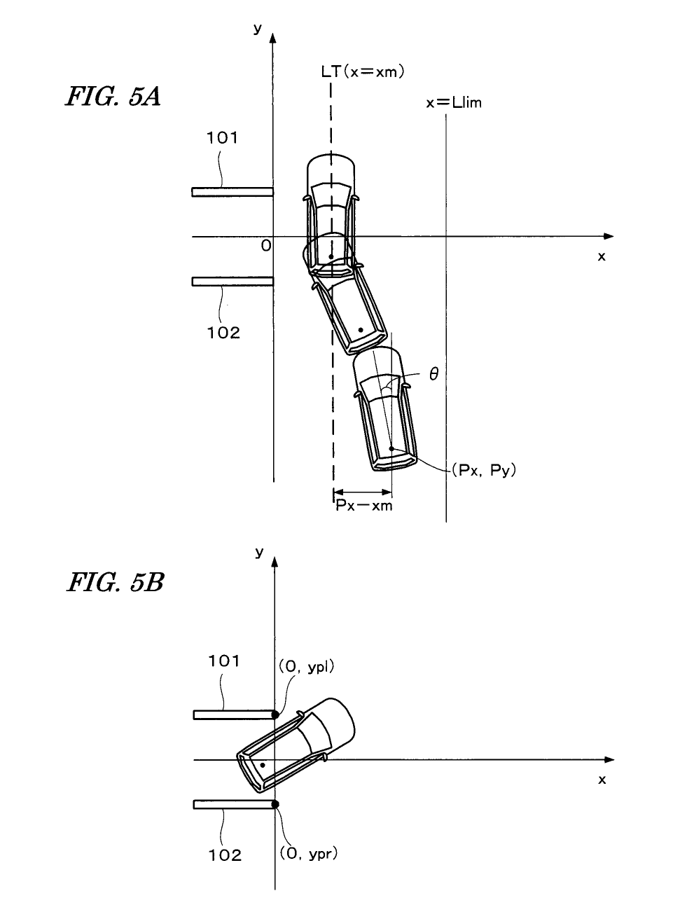

In step S1, a position of the parking space and a width of the passage in front of the parking space are detected using the video camera 11F and the radar 12F. For determining the position, coordinate axes are set as shown in FIG. 5A or 5B. That is, an edge of the passage on the side where the parking space is positioned is set as the y-axis, and the x-axis is set so that the origin corresponds to the middle point of the line where the parking space fronts on the passage. If the passage width is expressed by “LIM”, a straight line expressed by an equation of “x=Llim” is recognized as another edge of the passage on the opposite side with respect to the parking space.

In step S2, a parking direction is selected according to the detected position of the parking space. It should be noted that the process described herein is with respect to a case where the parking space is on the left side with respect to the moving direction of the vehicle as shown in FIGS. 5A and 5B.

In step S3, an inclination angle θ of the vehicle with respect to the y-axis and a position (Px, Py) of the vehicle are calculated using the coordinate axes defined in step S1. In step S4, as shown in FIG. 5A, a target locus is set to a straight line of “x=xm”. In step S5, it is determined whether the shift lever position SP is in a D-range (drive range). If the answer to step S5 is negative (NO), the shift lever position SP is shifted to D-range (step S6), and the process proceeds to step S7. If the answer to step S5 is affirmative (YES), the process immediately proceeds to step S7.

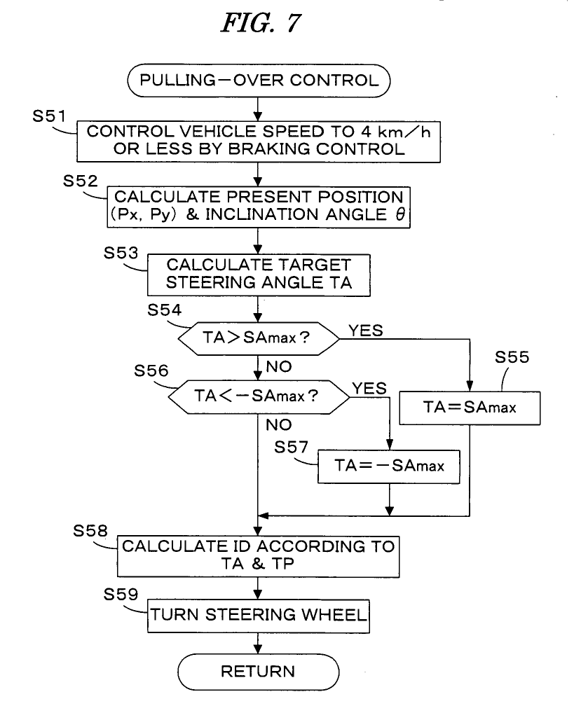

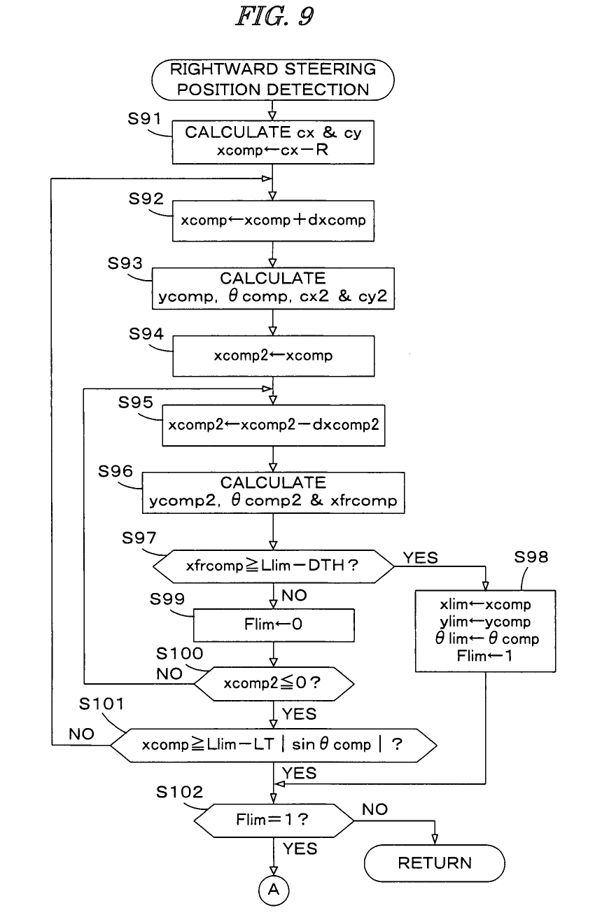

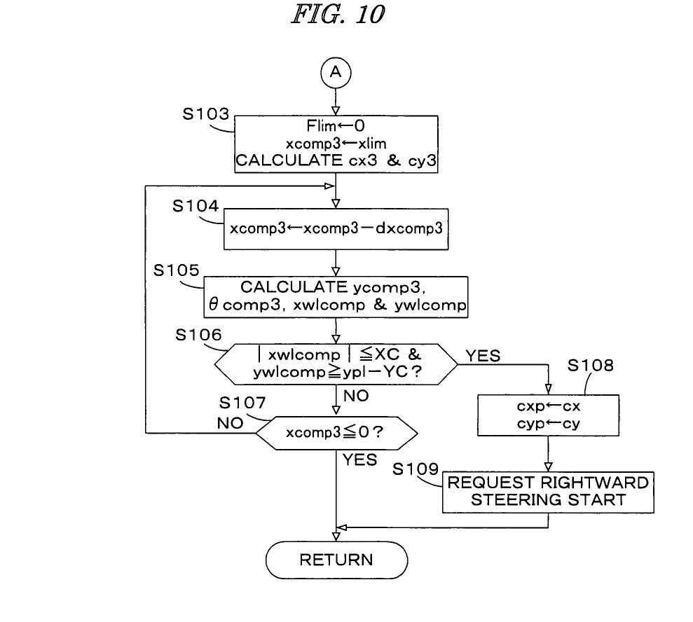

In step S7, a pulling-over control shown in FIG. 7 is performed. Next, in step S8, a rightward steering position detecting process shown in FIGS. 9 and 10 is performed. In the pulling-over control, the steering control is performed so that a running locus of the vehicle coincides with a straight target locus. Further, in the rightward steering position detecting process, an optimal position PR (hereinafter referred to as “rightward steering position”) for starting a rightward steering is detected. When the rightward steering position PR is detected, a rightward steering start request is made.

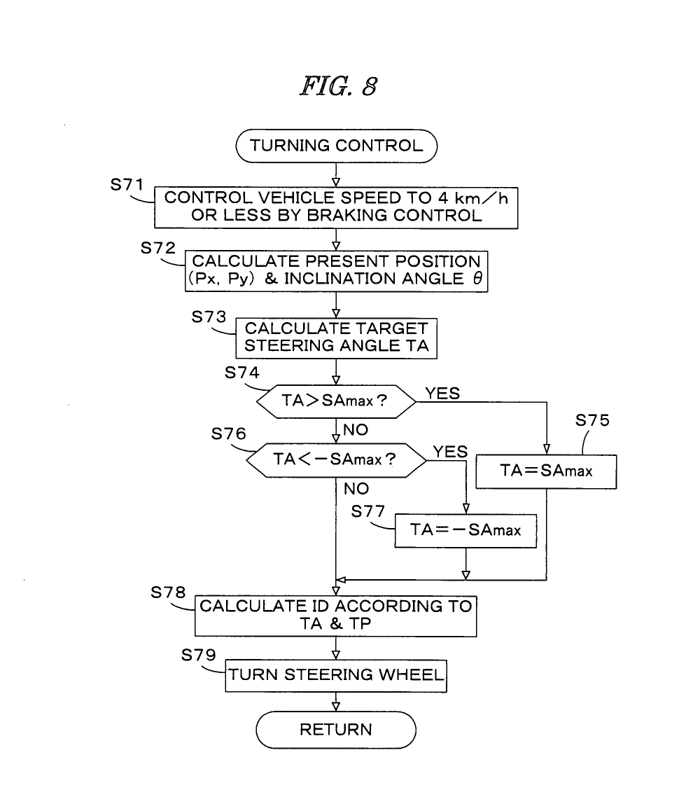

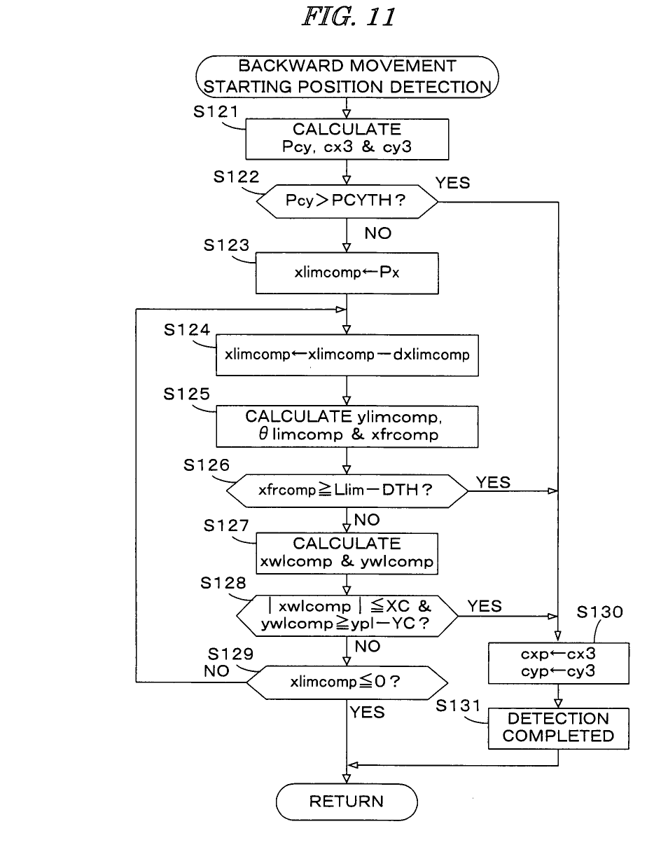

In step S9, it is determined whether the rightward steering start request has been made. If the answer to step S9 is negative (NO), the process returns to step S7. When the rightward steering start request has been made, the target locus is set to a turning circle CRL of the radius R (the minimum turning radius of the vehicle) having a center located on the right side of the vehicle (step S10) as shown in FIG. 6A. Further, a turning control shown in FIG. 8 is performed (step S11), and a backward movement starting position detecting process shown in FIG. 11 is performed (step S12). In the turning control, the steering control is performed wherein the running locus of the vehicle coincides with the turning circle CRL. In the backward movement starting position detecting process, a position PBS (hereinafter referred to as “backward movement starting position”), where the vehicle stops and starts to move backward, is detected.

In step S13, it is determined whether the backward movement starting position PBS has been detected. If the answer to step S13 is negative (NO), the process returns to step S11. If the backward movement starting position PBS has been detected, the process proceeds to step S14, wherein the vehicle is made to stop.

In step S21 (FIG. 4), the target locus is set to a turning circle CRL of the radius R (see FIG. 6B) having a center located on the left side of the vehicle. In step S22, the shift lever position is shifted to an R-range R (backward movement). Then, the turning control of FIG. 8 is performed (step S23). In step S24, distances DRRX and DRLX to an obstacle (or obstacles) located behind the vehicle are detected by the sonars 15 and 16 and the radar 12R. The distance DRRX corresponds to a distance from a position where the sonar sensor 16 is mounted on the rear bumper to an obstacle (hereinafter referred to as “right backward distance”). The distance DRLX corresponds to a distance from a position where the sonar sensor 15 is mounted on the rear bumper to an obstacle (hereinafter referred to as “left backward distance”).

In step S25, it is determined whether the inclination angle θ is less than an angle obtained by adding a predetermined angle θ C (e.g., 5 degrees) to −90 degrees. If the answer to step S25 is affirmative (YES), it is possible to maneuver the vehicle into the parking space without performing the cutting operation of the steering wheel. Therefore, the process immediately proceeds to step S33, wherein the target locus is set to the straight line of “y=0”, and the pulling-over control on the backward movement is performed (step S34). If the answer to step S25 is negative (NO), i.e., the inclination angle θ of the vehicle is comparatively great, it is determined whether a rear bumper position condition is satisfied (step S26). The rear bumper position condition is satisfied when any one of the following conditions CR1) to CR4) is satisfied.

DRRX≦DTH CR1)

DRLX≦DTH CR2)

yrr<ypr+K×V²×|cos θ| CR3)

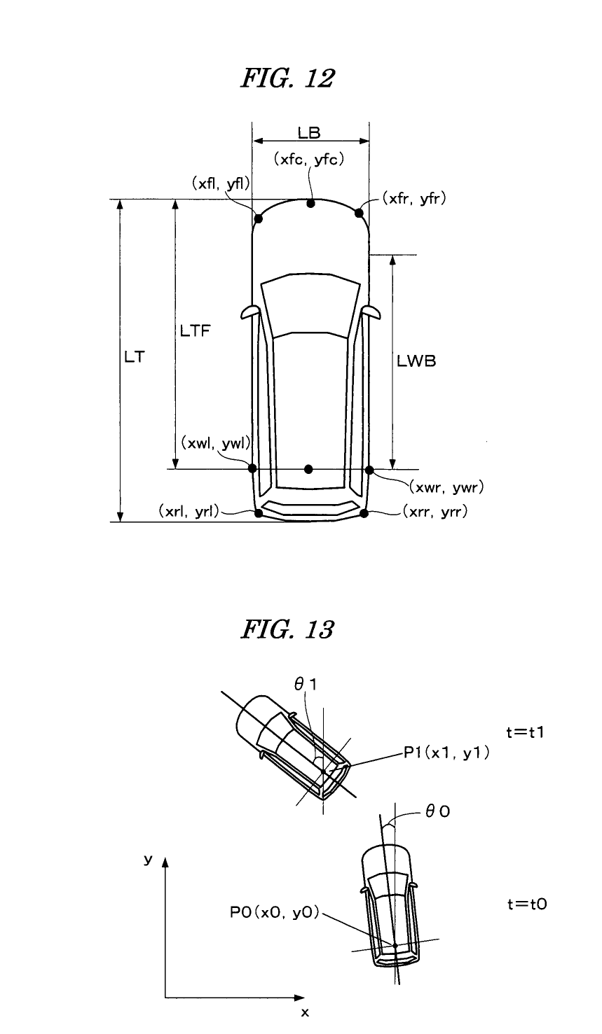

yrl>ypl−K×V²×|cos θ| CR4)

where “DTH” is a predetermined distance set to, for example, 0.1 [m]; “K” is a constant set to, for example, “0.05”; “V” is a vehicle speed; “yrr” is a y-coordinate of a predetermined right side position of the rear bumper (the position on which the sonar 16 is mounted); “yrl” is a y-coordinate of a predetermined left side position of the rear bumper (the position on which the sonar 15 is mounted); “ypr” is a y-coordinate of a right endpoint of the parking space entrance; and “ypl” is a y-coordinate of a left endpoint of the parking space entrance (see FIGS. 12 and 5B).

If the answer to step S26 is negative (NO), the process returns to step S23. If the rear bumper position condition is satisfied in step S26, a possibility that the rear bumper may scrape against the obstacle located behind the vehicle is high. Therefore, the process proceeds to step S27 to start the pulling-over control on the forward movement. In step S27, the target locus is set to the straight line of “y=0”, i.e., the x-axis. The shift lever position PS is shifted to the D range (step S28), and the pulling-over control is performed similarly to step S7 (step S29). In step S30, distances DFRX and DFLX to an obstacle (obstacles) located in front of the vehicle are detected by the sonars 13 and 14 and the radar 12F. The distance DFRX corresponds to a distance from a position where the sonar 14 is mounted on the front bumper to an obstacle (hereinafter referred to as “right forward distance”). The distance DFLX corresponds to a distance from a position where the sonar 13 is mounted on the front bumper to an obstacle (hereinafter referred to as “left forward distance”).

In step S31, it is determined whether a front bumper position condition is satisfied. The front bumper position condition is satisfied when any one of the following conditions CF1) to CF5) is satisfied.

DFRX≦DTH CF1)

DFLX≦DTH CF2)

xfr<Llim−(KA+K×V²×|sin θ|) CF3)

xfc<Llim−(KA+K×V²×|sin θ|) CF4)

xfl<Llim−(KA+K×V²×|sin θ|) CF5)

where “xfr” is an x-coordinate of a right side predetermined position of the front bumper (a position on which the sonar 14 is mounted), “xfl” is an x-coordinate of a left side predetermined position of the front bumper (a position on which the sonar 13 is mounted), “xfc” is an x-coordinate of the tip of the front bumper (see FIG. 12), and “KA” is a predetermined constant (e.g., 0.2 [m]), which is set according to an detection error of the sonar 13 or 14, and an calculation error of the position (Px, Py) of the vehicle.

If the answer to step S31 is negative (NO), the process returns to step S29.

If the front bumper position condition is satisfied in step S31, i.e., when a possibility that the front bumper may scrape against the obstacle (the right edge of the passage) is high, the process proceeds to step S32 to start the pulling-over control on the backward movement. In step S32, the shift lever position PS is shifted to the R range, and the target locus is set to the straight line of “y=0” (step S33). In step S34, the pulling-over control of FIG. 7 is performed. In step S35, the right backward distance DRRX and the left backward distance DRLX are detected in a manner similar to step S24. In step S36, it is determined whether the rear bumper position condition is satisfied.

If the answer to step S36 is negative (NO), it is determined whether the x-coordinate Px of the present position of the vehicle is equal to or less than a value obtained by multiplying “−1” by a value LTF of the length from the rear wheel to the front bumper tip of the vehicle (hereinafter referred to as “vehicle front part length LTF”, see FIG. 12). If the answer to step S37 is negative (NO), the process returns to step S33.

If the rear bumper position condition is satisfied in step S36, or the x-coordinate Px of the present position of the vehicle is equal to or less than “−LTF” in step S37, the process proceeds to step S39, wherein it is determined whether the absolute value of the y-coordinate Py of the present position of the vehicle is equal to or less than a predetermined value DPY (e.g., 0.15 m), and the absolute value of the result obtained by adding 90 degrees to the inclination angle θ is equal to or less than a predetermined angular difference DθX (e.g., 3 degrees). If the answer to step S39 is negative (NO), the process returns to step S27 and the pulling-over control on the forward movement is again performed.

Finally, when the answer to step S39 becomes affirmative (YES), it is determined that the parking (maneuvering the vehicle into the parking space) is completed and the process ends.

FIG. 7 is a flowchart showing a method of the pulling-over control performed in step S7 of FIG. 3 and in steps S29 and S34 of FIG. 4.

In step S51, the vehicle speed VP is controlled to a value equal to or less than 4 km/h by the brake control. Next, the present position (Px, Py) and the inclination angle θ of the vehicle are calculated (step S52). This calculation is performed based on a sequential calculation method described below with reference to FIG. 13. From the initial position P0 (x0, y0) and the initial inclination angle θ0 of the vehicle at time t0, the vehicle position P1 (x1, y1) and the inclination angle θ1 at time t1, after a time period ΔT has passed from time t0, is calculated as follows.

An inclination angle change amount dθ (degree) during the time period ΔT is given by equation (1), wherein “dLR” and “dLL” in equation (1) are, respectively, a right-rear wheel moved distance and a left-rear wheel moved distance which are obtained by multiplying the time period ΔT by the right wheel speed VWR and the left wheel speed VWL.

$$d θ = \frac{d L R - d L L}{L B} \times \frac{180}{π} \qquad ( 1 )$$

Therefore, the inclination angle θ1 is given by equation (2).

θ1=θ0+dθ (2)

An x-coordinate change amount dx and a y-coordinate change amount dy are respectively calculated by equations (3) and (4) using the inclination angle θ1.

dx=0.5×(dLR+dLL)×(−sin θ1) (3)

dy=0.5×(dLR+dLL)×cos θ1 (4)

Therefore, the coordinates of the vehicle position P1 at time t1 are calculated by equations (5) and (6).

x1=x0+dx (5)

y1=y0+dy (6)

Therefore, the vehicle position (Px, Py) and the inclination angle θ are sequentially calculated by detecting the initial position P0 (x0, y0) and the initial inclination angle θ0.

In step S53, a target steering angle TA is calculated by equation (7) so that the running locus of the vehicle coincides with the target locus (straight line). The target steering angle TA is defined to take a positive value when steering to the left, and takes a value in the range from −520 degrees (−SAmax) to 520 degrees (SAmax), for example.

TA=A×r+B×dθS (7)

In equation (7), “A” is a distance constant set to a predetermined positive value, “B” is an angular constant set to a predetermined positive value when the vehicle moves forward and set to a predetermined negative value when the vehicle moves backward, and “r” is a distance parameter obtained by attaching a plus/minus sign to a distance from the vehicle position to the target locus. The distance parameter “r” takes a positive value when the target locus is on the left side of the vehicle and takes a negative value when the target locus is on the right side. In step S7 of FIG. 3, the distance parameter “r” is calculated by equation (8a) since the target locus is the straight line of “x=xm”. Further, in steps S29 and S33 of FIG. 4, the distance parameter is calculated by equation (8b) since the target locus is the straight line of “y=0”.

r=Px−xm (8a)

r=−Py (8b)

Further, “dθS” in equation (7) is an angular deviation (θLT−θ) between the inclination angle θ of the vehicle and the inclination angle θLT of the target locus. In step S7 of FIG. 3, the angular deviation dθS is equal to “−θ” since the inclination angle θLT is equal to “0”. On the other hand, in steps S29 and S33 of FIG. 4, the angular deviation dθS is equal to “−90−θ” since the inclination angle θLT is equal to “−90”.

In steps S54 to S57, a limit process of the target steering angle TA is performed. That is, if the target steering angle TA is greater than the maximum value SAmax, the target steering angle TA is set to the maximum value SAmax (steps S54, S55). If the target steering angle TA is less than the minimum value −SAmax, the target steering angle TA is set to the minimum value −SAmax (steps S56, S57).

In step S58, a current value ID supplied to the steering actuator 3 is calculated according to the target steering angle TA and the present steering angle TP. Subsequently, the electric current of the current value ID is supplied to the steering actuator 3 to turn the steering wheel (step S59).

According to the process of FIG. 7, the steering control and the movement control are performed so that the running locus of the vehicle coincides with the target locus (straight line).

FIG. 8 is a flowchart showing a method of the turning control performed in step S11 of FIG. 3 and step S23 of FIG. 4.

Steps S71, S72, and S74 to S79 are the same as steps S51, S52, and S54 to S59 of FIG. 7.

In step S73, the target steering angle TA is calculated by equation (9) so that the running locus of the vehicle coincides with the target locus (turning circle).

TA=A×dR+B×dθ+TA0 (9)

In equation (9), “A” and “B” are, respectively, the distance constant “A” and the angular constant “B” in equation (7), and “dR” is a distance parameter indicative of a distance from the vehicle position (Px, Py) to the turning circle CRL as shown in is FIG. 6A. The distance parameter dR takes a positive value when the tangent line LTN at the intersection point of the straight line LPC and the turning circle CRL are on the left side of the vehicle, wherein the straight line LPC connects the vehicle position and the center (cx, cy) of the turning circle CRL. On the other hand, the distance parameter dR takes a negative value when the tangent line LTN is on the right side of the vehicle. The absolute value of the distance parameter dR is given by equation (10). Further, “dθ” is an angular deviation calculated by subtracting the inclination angle θ of the vehicle from an inclination angle θ′ of the tangent line LTN with respect to the y-axis. The angular deviation dθ is calculated by equations (11) and (12). “TA0” is a basic steering angle required for turning along the circle of radius “R”. The basic steering angle TA0 takes a positive value when turning in the counter-clockwise direction and takes a negative value when turning in the clockwise direction. The absolute value of TA0 is given by equation (13).

$$\begin{matrix}\vert dR \vert = \vert \sqrt{{( cx - Px )}^{2} + {( cy - Py )}^{2}} - R \vert & ( 10 ) \\ d θ = {θ}^{′} - θ & ( 11 ) \\ {θ}^{′} = {tan}^{- 1} \frac{cy - Py}{cx - Px} & ( 12 ) \\ \vert TA 0 \vert = C \cdot {tan}^{- 1} \frac{LWB}{R + 0.5 \cdot LB} & ( 13 )\end{matrix}$$

In equation (13), “LB” is a tread of the rear wheels, “LWB” is a wheel base (see FIG. 12), and “C” is a coefficient set to a ratio (TP/TW) of a steering wheel steering angle TP to an outer wheel turning angle TW. The outer wheel turning angle is a turning angle of one of the front wheels which traces the outer locus when turning the vehicle. The coefficient “C” is set to “16.2” for example. The outer wheel turning angle is used since the relationship between the steering angle TP and an inner wheel turning angle (which is a turning angle of one of the front wheels which traces the inner locus when turning the vehicle) is not strictly linear.

According to the process of FIG. 8, the steering control and the movement control are performed so that the running locus of the vehicle coincides with the target locus (turning circle).

FIGS. 9 and 10 show a flowchart of the rightward steering position detecting process executed in step S8 of FIG. 3.

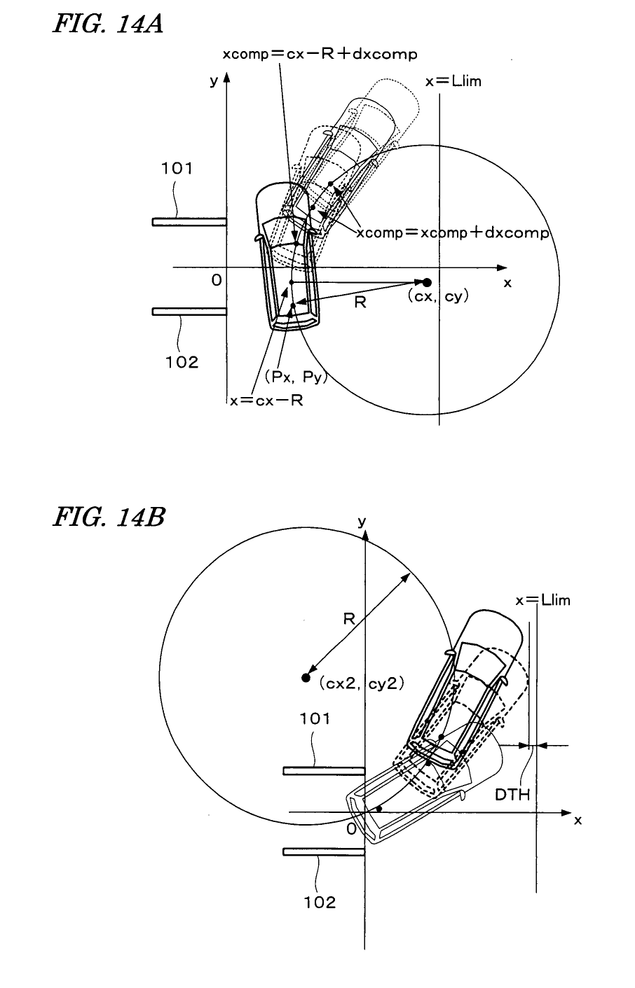

In step S91, center coordinates (cx, cy) of a first turning circle CRL1 as the target locus are calculated by equations (21) and (22). Further, a first predicted x-coordinate xcomp is calculated by equation (23) (see FIG. 14A).

cx=Px+R×cos θ (21)

cy=Py+R×sin θ (22)

xcomp=cx−R (23)

In step S92, the first predicted x-coordinate xcomp is increased by a predetermined amount dxcomp by equation (24).

xcomp=xcomp+dxcomp (24)

In step S93, a first predicted y-coordinate ycomp, a first predicted inclination angle θ comp, and center coordinates (cx2, cy2) of a second turning circle CRL2 are calculated by equations (25) to (28) (see FIG. 14B).

$$\begin{matrix}ycomp = cy + \sqrt{{R}^{2} - {( xcomp - cx )}^{2}} & ( 25 ) \\ \begin{matrix}θ comp = {tan}^{- 1} \frac{ycomp - cy}{xcomp - cx} ( xcomp - cx \neq 0 ) \\ θ comp = - 90 ( xcomp - cx = 0 )\end{matrix} \} & ( 26 ) \\ cx 2 = 2 \times xcomp - cx & ( 27 ) \\ cy 2 = 2 \times ycomp - cy & ( 28 )\end{matrix}$$

According to steps S92 and S93, vehicle position coordinates (xcomp, ycomp) and an inclination angle θ comp, which correspond to a predicted running locus when the vehicle gradually moves from the present position along the first turning circle CRL1, are calculated.

In step S94, a second predicted x-coordinate xcomp2 is set to the first predicted x-coordinate xcomp. In step S95, the second predicted x-coordinate xcomp2 is decreased by a predetermined change amount dxcomp2 by equation (31).

xcomp2=xcomp2−dxcomp2 (31)

In step S96, a second predicted y-coordinate ycomp2, a second predicted inclination angle θ comp2, and a right-front portion predicted x-coordinate xfrcomp are calculated by equations (32) to (34).

$$\begin{matrix}ycomp 2 = cy 2 - \sqrt{{R}^{2} - {( xcomp 2 - cx 2 )}^{2}} & ( 32 ) \\ θ comp 2 = {tan}^{- 1} \frac{ycomp 2 - cy 2}{xcomp 2 - cx 2} & ( 33 )\end{matrix}$$

xfrcomp=xcomp2+0.5×LB×cos θcomp2−LTF×sin θcomp2 (34)

where “LB” and “LTF” are, respectively, the tread of the rear wheels and the vehicle front part length.

According to steps S95 and S96, the vehicle position coordinates (xcomp2, ycomp2) and the second predicted inclination angle θ comp2, which correspond to a predicted running locus when the vehicle moves backward from a position (xcomp, ycomp) along the second turning circle CRL2 having a center of coordinates (cx2, cy2) as shown in FIG. 14B, are calculated. Further, the right-front portion predicted x-coordinate xfrcomp, which becomes maximum when the vehicle moves backward, is calculated. When the right-front portion predicted x-coordinate xfrcomp becomes maximum, the right-front portion of the vehicle is located at the point closest to the right edge of the passage (an obstacle on the right side).

In step S97, it is determined whether the right-front portion predicted x-coordinate xfrcomp is equal to or greater than a value obtained by subtracting a predetermined distance DTH from the x-coordinate Llim of the right edge of the passage. If the answer to step S97 is negative (NO), a right-front portion approach flag Flim is set to “0” (step S99). Next, it is determined whether the second predicted x-coordinate xcomp2 is equal to or less than “0” (step S100). The answer to step S100 is initially negative (NO), and the process returns to step S95.

If the answer to step S97 remains negative (NO) and the second predicted x-coordinate xcomp2 becomes equal to or less than “0”, the process proceeds from step S100 to step S101, wherein it is determined whether the first predicted x-coordinate xcomp is equal to or greater than a value which is obtained by subtracting a value obtained by multiplying |sin θcomp| by the vehicle length LT (see FIG. 12), from the passage right edge x-coordinate Llim. Since the answer to step S101 is initially negative (NO), the process returns to step S92, wherein the first predicted x-coordinate xcomp is increased. Thereafter, the same process is repeated.

Accordingly, the first predicted x-coordinate xcomp gradually increases. If the answer to step S101 becomes affirmative (YES), the process proceeds to step S102. On the other hand, if the answer to step S97 is affirmative (YES), i.e., if it is predicted that the vehicle right-front portion approaches the right edge of the passage, the process proceeds to step S98, wherein a right-front portion approach x-coordinate xlim, a right-front portion approach y-coordinate ylim, and a right-front portion approach inclination angle θlim are, respectively, set to present values of the first predicted x-coordinate xcomp, the first predicted y-coordinate ycomp, and the first predicted inclination angle θ comp. Further, the right-front portion approach flag Flim is set to “1”. Thereafter, the process proceeds to step S102.

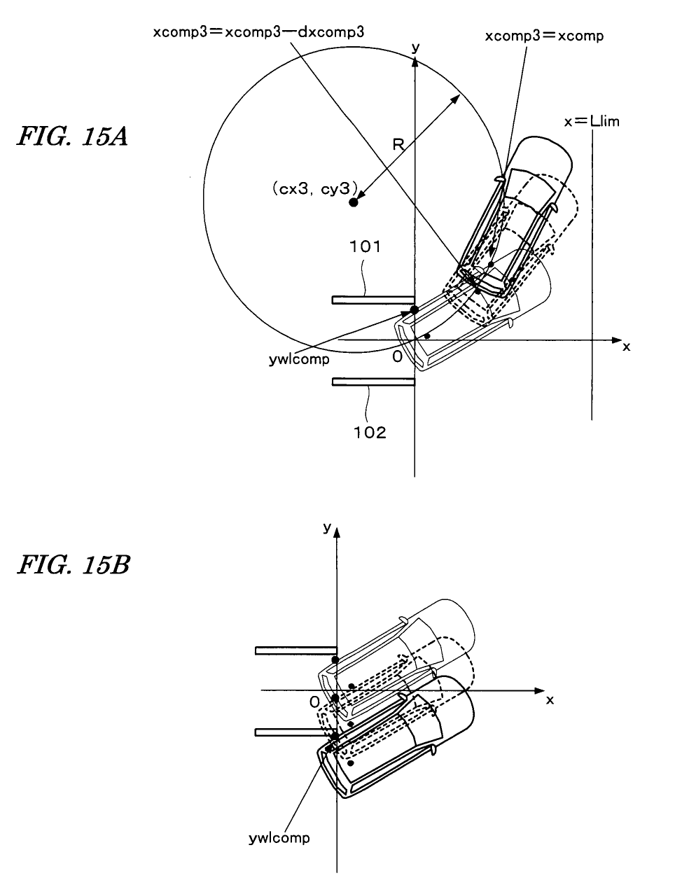

In step S102, it is determined whether the right-front portion approach flag Flim is equal to “1”. If the answer to step S102 is negative (NO), the process immediately ends. When Flim is equal to “1”, the process proceeds to step S103 (FIG. 10), in which the right-front portion approach flag Flim is returned to “0”, and a third predicted x-coordinate xcomp3 is set to the right-front portion approach x-coordinate xlim. Further, center coordinates (cx3, cy3) of a third turning circle CRL3 are calculated by equations (35) and (36) (see FIG. 15A).

cx3=2×xlim−cx (35)

cy3=2×ylim−cy (36)

In step S104, the third predicted x-coordinate xcomp3 is decreased by a predetermined change amount dxcomp3 by equation (41).

xcomp3=xcomp3−dxcomp3 (41)

In step S105, a third predicted y-coordinate ycomp3, a third predicted inclination angle θ comp3, a left-rear wheel predicted x-coordinate xwlcomp, and a left-rear wheel predicted y-coordinate ywlcomp are calculated by equations (42) to (45).

$$\begin{matrix}ycomp 3 = cy 3 - \sqrt{{R}^{2} - {( xcomp 3 - cx 3 )}^{2}} & ( 42 ) \\ θ comp 3 = {tan}^{- 1} \frac{ycomp 3 - cy 3}{xcomp 3 - cx 3} & ( 43 ) \\ xwlcomp = xcomp 3 - 0.5 \times LB \times cos θ comp 3 & ( 44 ) \\ ywlcomp = ycomp 3 - 0.5 \times LB \times sin θ comp 3 & ( 45 )\end{matrix}$$

In step S106, it is determined whether the absolute value of the left-rear wheel predicted x-coordinate xwlcomp is equal to or less than a predetermined distance XC (e.g., 0.1 m) and the left-rear wheel predicted y-coordinate ywlcomp is equal to or greater than a value obtained by subtracting a predetermined distance YC (e.g., 0.1 m) from a y-coordinate ypl of the left end of the parking space entrance. If the answer to step S106 is negative (NO), it is determined whether the third predicted x-coordinate xcomp3 is equal to or less than “0” (step S107). If the answer to step S107 is negative (NO), the process returns to step S104. If the answer to step S107 is affirmative (YES), the process immediately ends.

If the answer to step S106 is affirmative (YES), i.e., it is predicted that the left-rear wheel of the vehicle will enter a predetermined region RPC (a region defined by XC and YC) in the vicinity of the left end of the parking space entrance, center coordinates (cxp, cyp) of the actual steering turning circle CRLE are set to the present center coordinates (cx, cy) of the first turning circle CRL1 (step S108), and a rightward steering start request is made (step S109).

According to the process of FIGS. 9 and 10, a predicting calculation of the vehicle running locus is performed for the parking control wherein the vehicle turns right at the actual position (Px, Py) of the vehicle during execution of the pulling-over control on forward movement, stops, and moves backward with a certain margin with respect to the right edge of the passage (x=Llim). When the predicting calculation indicates that the left-rear wheel coordinates of the vehicle will finally enter the predetermined region RPC in the vicinity of the left end of the parking space entrance, the rightward steering start request is made.

The calculation shown in FIGS. 9 and 10 is repeatedly performed during the pulling-over control on forward movement of the vehicle. The predicted vehicle position at the time the predicted x-coordinate of the vehicle becomes “0” gradually shifts in the direction of increasing the y-coordinate of the predicted vehicle position. When the predicted position of the left-rear wheel approaches the left end of the parking space entrance (the state shown by the thin solid line in FIG. 15B), the rightward steering start request is made. Therefore, the rightward steering is started at the most suitable timing.

FIG. 11 is a flowchart showing the backward movement starting position detecting process executed in step S12 of FIG. 3.

In step S121, a determination y-coordinate Pcy and center coordinates (cx3, cy3) of the third turning circle CRL3 are calculated by equations (51) to (53).

$$\begin{matrix}Pcy = Py - tan θ \frac{R}{\sqrt{{tan}^{2} θ + 1}} & ( 51 ) \\ cx 3 = 2 \times Px - cx & ( 52 ) \\ cy 3 = 2 \times Py - cy & ( 53 )\end{matrix}$$

In step S122, it is determined whether the determination y-coordinate Pcy is greater than a determination threshold value PCYTH calculated by equation (54).

PCYTH=R−K×V²×|cos θ| (54)

where “K” is a constant set to “0.05”, for example, and “V” is the vehicle speed.

If the answer to step S122 is affirmative (YES), the vehicle is positioned in the parking space in one backward movement by immediately stopping the vehicle and starting the backward movement. Therefore, the process proceeds to step S130, wherein the center coordinates (cxp, cyp) of the actual steering turning circle CRLE are set to the present center coordinates (cx3, cy3) of the third turning circle CRL3, and the backward movement starting position detection is completed (step S131).

If the answer to step S122 is negative (NO), a fourth predicted x-coordinate xlimcomp is set to the present vehicle position x-coordinate Px (step S123). In step S124, the fourth predicted x-coordinate xlimcop is decreased by a predetermined change amount dxlimcomp by equation (55).

xlimcomp=xlimcomp−dxlimcomp (55)

In step S125, a fourth predicted y-coordinate ylimcomp, a fourth predicted inclination angle θ limcomp, and the right-front portion predicted x-coordinate xfrcomp are calculated by equations (56) to (58).

$$\begin{matrix}y lim comp = cy 3 - \sqrt{{R}^{2} - {( x lim comp - cx 3 )}^{2}} & ( 56 ) \\ \begin{matrix}θ lim comp = {tan}^{- 1} \frac{y lim comp - cy 3}{x lim comp - cx 3} ( x lim comp - cx 3 \neq 0 ) \\ θ lim comp = - 90 ( x lim comp - cx 3 = 0 )\end{matrix} \} & ( 57 ) \\ xfrcomp = x lim comp + 0.5 \times LB \times cos θ lim comp - LTF \times sin θ lim comp & ( 58 )\end{matrix}$$

In step S126, it is determined whether the right-front portion predicted x-coordinate xfrcomp is equal to or greater than a value obtained by subtracting a predetermined distance DTH from the passage right edge x-coordinate Llim. If the answer to step S126 is affirmative (YES), it is estimated that there is no margin in the distance between the right-front portion of the vehicle and the right edge of the passage. Therefore, the process proceeds to step S130.

If the answer to step S126 is negative (NO), the left-rear wheel predicted x-coordinate xwlcomp and the left-rear wheel predicted y-coordinate ywlcomp are calculated by equations (59) and (60) (step S127).

xwlcomp=xlimcomp−0.5×LB×cos θlimcomp (59)

ywlcomp=ylimcomp−0.5×LB×sin θlimcomp (60)

In step S128, the same determination as that in step S106 of FIG. 10 is performed, i.e., it is determined whether the predicted position of the left-rear wheel is in the predetermined region RPC located in the vicinity of the left end of the parking space entrance. If the answer to step S128 is negative (NO), it is determined whether the fourth predicted x-coordinate xlimcomp is equal to or less than “0” (step S129). If the answer to step S129 is negative (NO), the process returns to step S124. If the answer to step S129 is affirmative (YES), the process ends.

If the answer to step S128 becomes affirmative (YES), the process proceeds to step S130 described above. That is, the center coordinates (cxp, cyp) of the actual steering turning circle CRLE are set to the present center coordinates (cx3, cy3) of the third turning circle CRL3, and the backward movement starting position detection is completed (step S131).

In the process shown in FIGS. 3, 4, and 7 to 11, the case where the parking space is on the left side with respect to the movement direction of the vehicle is described. The similar process is applicable to the case where the parking space is on the right side with respect to the movement direction of the vehicle.

As described above, in this embodiment, the parking control is performed as follows in an example where the parking space is on the left side of the movement direction of the vehicle: the vehicle is moved forward from the initial position, the steering wheel 1 is turned rightward at the rightward steering position PR, and the vehicle is moved forward in the opposite direction with respect to the parking space. The vehicle is then stopped when the vehicle reaches the backward movement starting position PBS. The steering wheel 1 is then turned leftward, and the vehicle is moved backward to put the vehicle into the parking space. The backward movement starting position PBS is calculated as a position where the vehicle is able to move so that a predetermined portion in the right-front part of the front bumper is kept away from the right edge of the passage (an obstacle on the right side of the passage) by the predetermined distance DTH or more when the vehicle moves backward to the parking space. The predetermined portion of the front bumper is defined as a portion which passes a closest point to the right edge of the passage (an obstacle on the right side of the passage). The rightward steering position PR is calculated as a position where a predetermined portion of the left-rear part of the rear bumper of the vehicle enters the predetermined region RPC located in the vicinity of the left end of the parking space entrance when the vehicle moves backward to the parking space from the backward movement starting position PBS. Therefore, the vehicle is controlled to move backward without scraping the right-front predetermined portion of the vehicle against the right edge of the passage (the obstacle), so that the left-rear predetermined portion of the vehicle enters the predetermined region RPC located in the vicinity of the left endpoint of the parking space entrance. That is, the vehicle is accurately and easily parked in the parking space or moved to the position where the cutting or turning operation of the steering wheel is possible without scraping the front bumper against the obstacle on the opposite side with respect to the parking space during the backward movement.

Further, the pulling-over control is performed so that the distance in the lateral direction between the vehicle and the parking space decreases when the vehicle moves forward from the initial position to the rightward steering position PR. That is, the vehicle is pulled over in the direction to the parking space before starting the rightward steering. Accordingly, when the distance in the lateral direction between the initial position of the vehicle and the parking space is significant, the passage width in front of the parking space is effectively used, thereby reducing a number of times of the cutting or turning operation of the steering wheel until completing the parking process.

Further, the vehicle is stopped and the cutting operation of the steering wheel, wherein the steering wheel is turned rightward and the vehicle is moved forward, is performed when an obstacle located behind the vehicle is detected during the backward movement. Accordingly, the vehicle is easily and accurately parked in the parking space even when the passage width in front of the parking space is relatively narrow.

In this embodiment, the steering actuator 3 corresponds to a steering means, and the ECU 5, the brake actuator 9, and the shift actuator 10 define a steering/movement control means. Further, the video camera 11F, the radar 12F, and the ECU 5 define a recognizing means; the video camera 11F, the radar 12F, the left wheel speed sensor 7, the right wheel speed sensor 8, and the ECU 5 form a position detecting means; the video cameras 11F and 11R, the radars 12F and 12R, sonars 13 to 16, and the ECU 5 form an obstacle detecting means; and the ECU 5 defines a backward movement starting position calculating means and the steering position calculating means. Specifically, the process of FIG. 11 corresponds to the backward movement starting position calculating means, and the process of FIGS. 9 and 10 corresponds to the steering position calculating means.

The present invention is not limited to the embodiment described above, and various modifications may be made. For example, in the above-described embodiment, the initial position and the initial inclination angle are calculated from the data obtained by the video camera 11F and the radar 12F. Alternatively, if the accuracy of the initial position and the initial inclination angle is not sufficient, the driver may input the data thereof, or the initial position and the initial inclination angle may be preliminarily determined and the driver may operate the vehicle to be in the predetermined state.

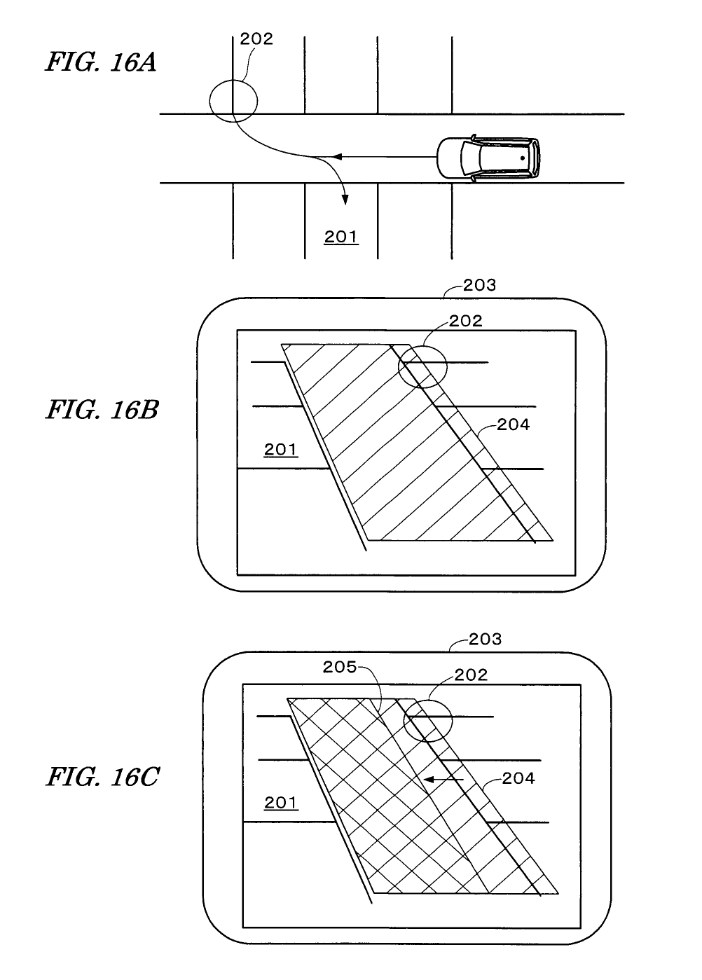

Further, as shown in FIG. 16A, when there exists an obstacle 202 which blocks the vehicle parking in a parking space 201, it is preferable to show a vehicle moving area 204 superimposed on the image obtained by the video camera 11F on a display 203 as shown in FIG. 16B. The vehicle moving area 204 is an area which is necessary for maneuvering the vehicle into the parking space by an ordinary automatic parking control. Further, it is preferable to provide an on/off switch for the display and perform the display when the driver turns on the on/off switch. For example, the display of a navigation system may be used as the display 203. According to the indication of the vehicle moving area 204, the driver can recognize that the vehicle cannot be maneuvered into the parking space 201 by the ordinary automatic parking control because of the obstacle 202.

Further, upon the driver's request, it is preferable to show a minimum moving area 205 for the parking which is determined according to the performance limit of the vehicle as shown in FIG. 16C. The automatic parking control may be performed upon the driver's request by limiting the moving area of the vehicle within the minimum moving area 205. Therefore, the automatic parking is performed when the obstacle 202 is located outside the minimum moving area 205 even if the obstacle 202 exists.

The present invention may be embodied in other specific forms without departing from the spirit or essential characteristics thereof. The presently disclosed embodiments are therefore to be considered in all respects as illustrative and not restrictive, the scope of the invention being indicated by the appended claims, rather than the foregoing description, and all changes which come within the meaning and range of equivalency of the claims are, therefore, to be embraced therein.

What is claimed is:

1. An automatic parking control apparatus for a vehicle, the control apparatus comprising:
steering means for turning a steering wheel of the vehicle;
steering/movement control means for performing a steering control with said steering means, a movement control for moving the vehicle forward or backward at a low speed, and a stop control for stopping the vehicle;
recognizing means for recognizing a parking space located on a side of the vehicle relative to a moving direction of the vehicle, and an initial position of the vehicle with reference to a position of the parking space, in response to a predetermined operation;
obstacle detecting means for detecting an obstacle located on an opposite side of the parking space relative to the moving direction of the vehicle; and
position detecting means for detecting a position of the vehicle,
wherein said steering/movement control means performs the steering control, the movement control, and the stop control so that the vehicle moves forward from the initial position; the steering wheel rotates in a first direction in order to move the vehicle forward from a first direction steering position in an opposite direction with respect to the parking space; the vehicle stops when the vehicle reaches a backward movement starting position; the steering wheel rotates in a second direction, which is opposite to the first direction; and the vehicle moves backward into the parking space,
wherein said steering/movement control means includes:
backward movement starting position calculating means for calculating the backward movement starting position as a position where the vehicle is able to move so that a first predetermined portion of the vehicle is kept away from the obstacle by a predetermined distance or more when the vehicle moves backward to the parking space, the first predetermined portion being defined as a portion which passes a closest point to the obstacle; and
steering position calculating means for calculating the first direction steering position as a position where a positional relationship between a second predetermined portion of the vehicle and the parking space satisfies a predetermined positional relationship when the vehicle moves backward to the parking space from the backward movement starting position.

2. The automatic parking control apparatus according to claim 1, wherein said steering/movement control means performs the steering control wherein a distance in a lateral direction between the vehicle and the parking space decreases when the vehicle moves forward from the initial position to the first direction steering position.

3. The automatic parking control apparatus according to claim 1, further comprising second obstacle detecting means on a rear part of the vehicle, wherein said steering/movement control means performs a turning operation of the steering wheel so that the vehicle stops when the second obstacle detecting means detects an obstacle during backward movement of the vehicle; the steering wheel rotates in the first direction; and the vehicle moves forward.

4. An automatic parking control method for a vehicle having a control unit for performing a steering control for turning a steering wheel of the vehicle, a movement control for moving the vehicle forward or backward at a low speed, and a stop control for stopping the vehicle, said control method comprising the steps of:
a) recognizing a parking space located on a side of the vehicle relative to a moving direction of the vehicle, and an initial position of the vehicle with reference to a position of the parking space, in response to a predetermined operation;
b) moving the vehicle forward from the initial position;
c) turning the steering wheel in a first direction in order to move the vehicle forward from a first direction steering position in an opposite direction with respect to the parking space;
d) detecting an obstacle located on an opposite side of the parking space relative to the moving direction of the vehicle;
e) stopping the vehicle when the vehicle reaches a backward movement starting position;
f) turning the steering wheel in a second direction, which is opposite to the first direction; and
g) moving the vehicle backward into the parking space,
wherein the backward movement starting position is calculated as a position where the vehicle is able to move so that a first predetermined portion of the vehicle is kept away from the obstacle by a predetermined distance or more when the vehicle moves backward to the parking space, the first predetermined portion being defined as a portion which passes a closest point to the obstacle detected in said step d); and
the first direction steering position is calculated as a position where a positional relationship between a second predetermined portion of the vehicle and the parking space satisfies a predetermined positional relationship when the vehicle moves backward to the parking space from the backward movement starting position.

5. The automatic parking control method according to claim 4, wherein the steering control is performed wherein a distance in a lateral direction between the vehicle and the parking space decreases when the vehicle moves forward from the initial position to the first direction steering position.

6. The automatic parking control apparatus according to claim 4, further comprising the step of detecting an obstacle located behind the vehicle, wherein a turning operation of the steering wheel is performed so that the vehicle stops when an obstacle is detected during backward movement of the vehicle; the steering wheel rotates in the first direction; and the vehicle moves forward.
